(19) United States
(12) Patent Application Publication
(10) Pub. No.: US 2019/0294742 A1
(43) Pub. Date: Sep. 26, 2019

(54) METHOD AND SYSTEM FOR SIMULATING VISUAL DATA

(71) Applicant: SZ DJI TECHNOLOGY CO., LTD., Shenzhen (CN)

(72) Inventors: Kaiyong ZHAO, Shenzhen (CN); Yao YAO, Shenzhen (CN); Yuewen MA, Shenzhen (CN)

(21) Appl. No.: 16/441,878

(22) Filed: Jun. 14, 2019

Related U.S. Application Data
(63) Continuation of application No. PCT/CN2016/110555, filed on Dec. 17, 2016.

(51) Int. Cl. G06F 17/50; G01M 11/02; G01J 1/44

(52) U.S. Cl. CPC G06F 17/5009; G01M 11/0221; G01J 2001/442; G01M 11/0257; G01J 1/44; G01M 11/0235

(57) ABSTRACT

A visual simulation system includes a non-transitory computer-readable memory that stores computer-executable instructions and one or more processors individually or collectively configured to access the memory. The one or more processors are individually or collectively configured to execute the computer-executable instructions to generate visual data of a virtual environment obtained by a simulated visual sensor associated with a simulated movable object, obtain one or more parameters of a physical visual sensor corresponding to the simulated visual sensor, the one or more parameters comprising a noise-related parameter, and transform the generated visual data to simulate an effect of the one or more parameters.

### CROSS-REFERENCE TO RELATED APPLICATION

This application is a continuation of International Application No. PCT/CN2016/110555, filed on Dec. 17, 2016, the entire content of which is incorporated herein by reference.

### BACKGROUND

Many applications require simulated visual data to train operating personnel, provide training data for machine learning, verify models, or improve hardware designs. As a cost-efficient substitution for real-environment image capturing, image simulation creates visual effects to resemble those captured by physical equipment. The simulation can be used as feedback to help adjust algorithms of those applications. To this end, the ideal simulation images should be indistinguishable from images physically captured in the field. However, current simulations often produce images unattainable with existing physical devices. In some applications, these simulated images can be detrimental to product performance, since any deviation from the reality can lead to erroneous calculations and algorithms associated with the product.

### SUMMARY

One aspect of the present disclosure is directed to a visual simulation system. The system may comprise a non-transitory computer-readable memory that stores computer-executable instructions. The system may further comprise one or more processors, individually or collectively, configured to access the memory and execute the computer-executable instructions to generate visual data of a virtual environment obtained by a simulated visual sensor associated with a simulated movable object, obtain one or more parameters of a physical visual sensor corresponding to the simulated visual sensor, the one or more parameters comprising a noise-related parameter, and transform the generated visual data to simulate an effect of the one or more parameters.

Another aspect of the present disclosure is directed to a visual simulation method. The method may comprise generating visual data of a virtual environment obtained by a simulated visual sensor associated with a simulated movable object, obtaining one or more parameters of a physical visual sensor corresponding to the simulated visual sensor, the one or more parameters comprising a noise-related parameter, and transforming the generated visual data to simulate an effect of the one or more parameters.

Another aspect of the present disclosure is directed to one or more non-transitory computer-readable storage media having stored thereon executable instructions that, when executed by one or more processors of a system, cause the system to perform a method. The method may comprise generating visual data of a virtual environment obtained by a simulated visual sensor associated with a simulated movable object, obtaining one or more parameters of a physical visual sensor corresponding to the simulated visual sensor, the one or more parameters comprising a noise-related parameter, and transforming the generated visual data to simulate an effect of the one or more parameters.

Another aspect of the present disclosure is directed to a visual simulation server. The server may comprise one or more non-transitory computer-readable storage media having stored thereon executable instructions that, when executed by one or more processors of the server, cause the server to perform a method. The method may comprise generating visual data of a virtual environment obtained by a simulated visual sensor associated with a simulated movable object, obtaining one or more parameters of a physical visual sensor corresponding to the simulated visual sensor, the one or more parameters comprising a noise-related parameter, and transforming the generated visual data to simulate an effect of the one or more parameters.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this disclosure, illustrate several embodiments and, together with the description, serve to explain the disclosed principles.

FIG. 1 is a block diagram illustrating a system for simulating visual data, consistent with exemplary embodiments of the present disclosure.

FIG. 2 is a block diagram illustrating a system for simulating visual data, consistent with exemplary embodiments of the present disclosure.

FIG. 3 is a block diagram illustrating a movable object, consistent with exemplary embodiments of the present disclosure.

FIG. 4 is a flowchart illustrating data exchange among a system for simulating visual data, consistent with exemplary embodiments of the present disclosure.

FIG. 5 is a flowchart illustrating a method for simulating visual data, consistent with exemplary embodiments of the present disclosure.

FIG. 6 is a ray diagram illustrating a lens distortion, consistent with exemplary embodiments of the present disclosure.

FIG. 7 is a ray diagram illustrating a fisheye model, consistent with exemplary embodiments of the present disclosure.

FIG. 8 is a flowchart illustrating a method for simulating visual data, consistent with exemplary embodiments of the present disclosure.

FIG. 9 is a flowchart illustrating a method for simulating photon noise, consistent with exemplary embodiments of the present disclosure.

FIG. 10 is a flowchart illustrating a method for simulating heat noise, consistent with exemplary embodiments of the present disclosure.

FIG. 11 is a flowchart illustrating a method for simulating visual data, consistent with exemplary embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. For brevity, the descriptions of components in one embodiment may be applicable to the same or similar components in a different embodiment, although different reference numbers may be used to refer the components in the different embodiment. The implementations set forth in the following description of exemplary embodiments consistent with the present disclosure do not represent all implementations consistent with the disclosure. Instead, they are merely examples of systems and methods consistent with aspects related to the disclosure.

In order to supply the most realistic simulation of the target apparatus, various methods have been sought. One traditional method is to capture the visual data with a physical apparatus in real locations for future displaying in a simulator. Such method is inefficient and expensive. In particular, capturing visual data at particular locations, e.g., deserts, mountains, and oceans, can be very demanding. Another traditional method is to directly modify existing videos into simulated visual data. However, adjusting viewing angles or other parameters beyond those comprised in the existing source is almost impossible for such method. Further, currently simulated visual data is often too perfect to be realistic, for not considering noises associated with physical sensors. That is, current visual data simulation technologies fail to realistically simulate visual data captured by virtual apparatuses such as UAV-based cameras, let alone the noise of such cameras. The disclosed systems and methods can realistic simulate such visual data at least by simulating the noise associated with the cameras, thereby mitigating or overcoming one or more of the problems set forth above. The simulated visual data can be used as input to various vision-based algorithms, and/or for testing various hardware components such as UAVs, remote controllers, and the like.

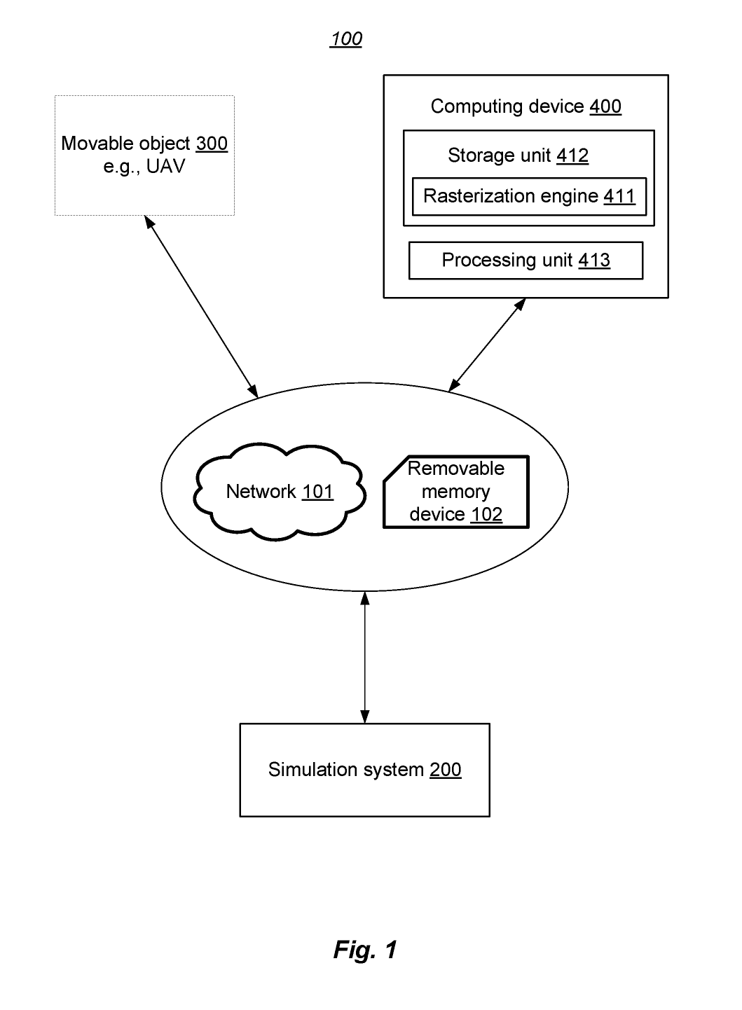

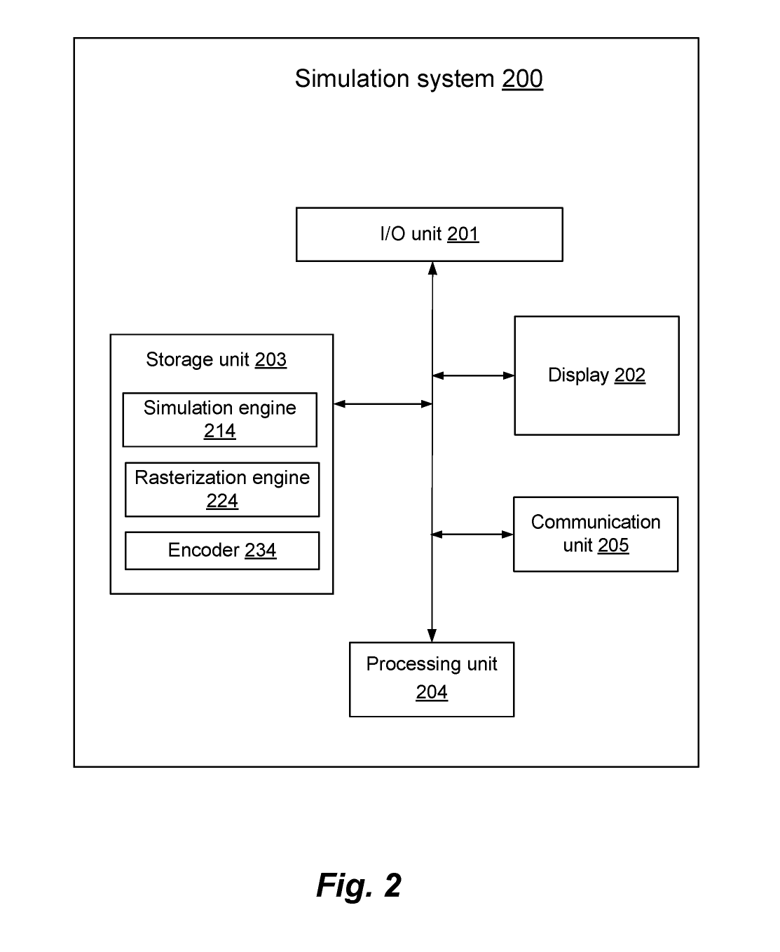

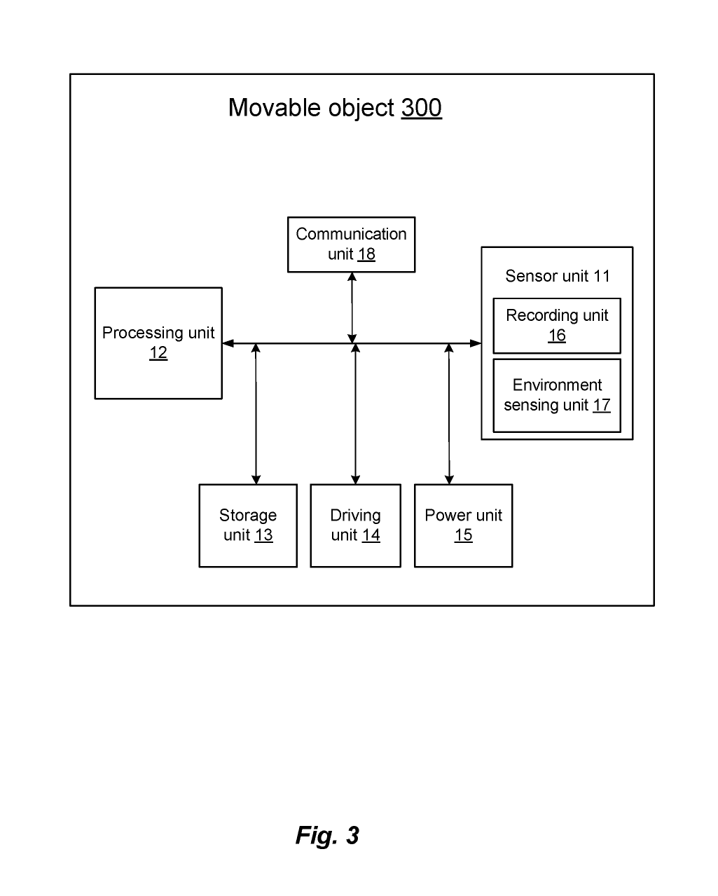

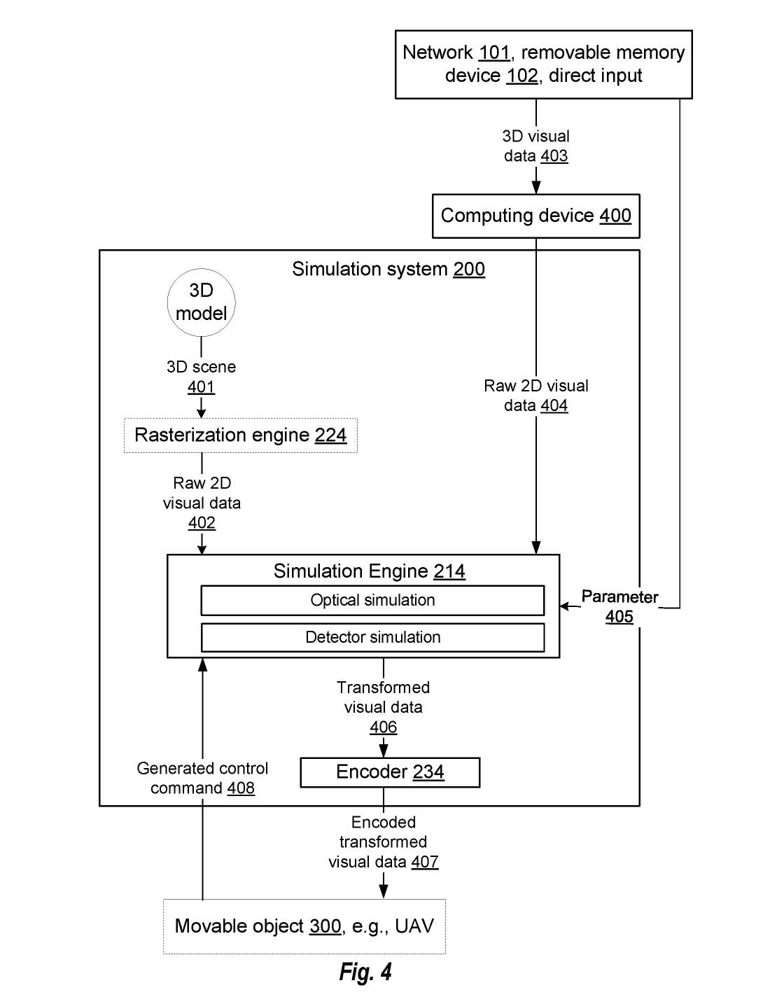

FIG. 1 is a block diagram illustrating a system 100 for simulating visual data, consistent with exemplary embodiments of the present disclosure. The system 100 may comprise a movable object 300, a computing device 400, and a simulation system 200, all of which coupled through a network 101 and/or a removable memory device 102. These components of system 100 may be physical components. In some embodiments, one or more components shown in FIG. 1 may be optional, such as the computing device 400. In some embodiments, the system 100 may include many more components than those shown in FIG. 1. However, it is not necessary that all of these components be shown in order to disclose an illustrative embodiment. For example, the simulation system 200 alone can simulate the visual data described herein, e.g., by performing method 500 discussed below. The various devices/objects/systems of the system 100 are introduced below. More detailed description regarding the various devices may be provided below with reference to FIG. 2 and FIG. 3. Interaction among the various devices of the system 100 is described with reference to FIG. 4.

The network 101 may be a wire/cable-based or wireless connection, e.g., wire, radio, Bluetooth, cloud connection, 4G/LTE, or WiFi, which allows data and signal transmission among the movable object 300, the computing device 400, and the simulation system 200. The network 101 may also comprise network devices, such as cloud computers or servers configured to store or relay signals and data. Alternative to the network 101, data, files, and/or instructions may be transferred or exchanged among the various devices of the system 100 through a removable memory device 102, such as a secure digital (SD) card or a USB drive. In some embodiments, regardless of using the network 101 or the removable memory device 102, the transmission of data or signals may be, for example, a universal serial bus (USB) transmission, a mobile industry processor interface (MIPI) transmission, a file transmission, or a network transmission, following various protocols such as, a transmission control protocol (TCP), a user datagram protocol (UDP), a UDP-based data transfer protocol (UDT), or a Webscoket protocol.

The simulation system 200 is described in more details below with reference to FIG. 2. In some embodiments, the simulation system 200 may be configured to perform one or more methods describe herein for simulating visual data, e.g., method 500. The simulation system 200 may be implemented as or as a part of a variety of devices, such as a computer, a server, a tablet, a simulation station, a simulator, a mobile phone, a network device, a controller, etc. In some embodiments, the simulation system 200 may be implemented as a part of the movable object 300, e.g., a part of a UAV.

The computing device 400 can be provided by the same entity that provides the simulation system 200 or a different entity (e.g., cloud service provider). The computing device 400 may comprise a number of components, such as a storage unit 412 and a processing unit 413, some of which may be optional. The computing device 400 may be implemented as or as a part of a variety of devices, such as a computer, a server, a tablet, a mobile phone, a network device, a controller, a satellite, a signal tower, etc. The storage unit 412 may be implemented as transitory and/or non-transitory storage media or memories configured to store data, logic, code, and/or program instructions executable by the processing unit 413 for performing one or more routines or functions, and/or steps and method, such as rasterization. The storage unit 412 may comprise instructions for implementing a rasterization engine 411. In some other embodiments, the rasterization engine 411 or portions of it may be implemented by hardware (e.g., application-specific integrated circuit (ASIC), graphics processing unit (GPU), field-programmable gate array (FPGA)), or a combination of both hardware and software. The rasterization engine 411 may include, for example, Unreal Engine, Unity 3D, or CryEngine. The rasterization engine 411 may be configured to render images based on raw images, e.g., converting a 3D scene to a 2D image for display. In some embodiments, the rasterization engine is a part of the simulation system 200 as described below with reference to FIG. 2, instead of a part of the computing device 400. In some other embodiments, the rasterization engine is provided in a separate device or system coupled to the network 101 and/or the removable memory device 102. The separate device or system may or may not be provided by a computing device.

The movable object 300 is described generally here, and detailed descriptions of its components and functions are provided below with reference to FIG. 3. The movable object may be configured to move within any suitable environment, such as in air (e.g., a fixed-wing aircraft, a rotary-wing aircraft, or an aircraft having neither fixed wings nor rotary wings), in water (e.g., a ship or a submarine), on ground (e.g., a motor vehicle, such as a car, truck, bus, van, motorcycle; a movable structure or frame such as a stick, fishing pole; or a train), under the ground (e.g., a subway), in space (e.g., a spaceplane, a satellite, or a probe), or any combination of these environments. The environment(s) may be simulated. The movable object may be mounted on a living subject, such as a human or an animal. Suitable animals may include avines, canines, felines, equines, bovines, ovines, porcines, delphines, rodents, or insects.

The movable object may be capable of moving freely within the environment with respect to six degrees of freedom (e.g., three degrees of freedom in translation and three degrees of freedom in rotation). Alternatively, the movement of the movable object may be constrained with respect to one or more degrees of freedom, such as by a predetermined path, track, or orientation. The movement may be actuated by any suitable actuation mechanism, such as an engine or a motor. The actuation mechanism of the movable object may be powered by any suitable energy source, such as electrical energy, magnetic energy, solar energy, wind energy, gravitational energy, chemical energy, nuclear energy, or any suitable combination thereof. The movable object may be self-propelled via a propulsion system, as described elsewhere herein. The propulsion system may optionally run on an energy source, such as electrical energy, magnetic energy, solar energy, wind energy, gravitational energy, chemical energy, nuclear energy, or any suitable combination thereof.

In some instances, the movable object may be a vehicle. Suitable vehicles may include water vehicles, aerial vehicles, space vehicles, or ground vehicles. For example, aerial vehicles may be fixed-wing aircraft (e.g., airplane, gliders), rotary-wing aircraft (e.g., helicopters, rotorcraft), aircraft having both fixed wings and rotary wings, or aircraft having neither (e.g., blimps, hot air balloons).

A vehicle may be self-propelled, such as self-propelled through the air, on or in water, in space, or on or under the ground. A self-propelled vehicle may utilize a propulsion system, such as a propulsion system including one or more engines, motors, wheels, axles, magnets, rotors, propellers, blades, nozzles, or any suitable combination thereof. In some instances, the propulsion system may be used to enable the movable object to take off from a surface, land on a surface, maintain its current position and/or orientation (e.g., hover), change orientation, and/or change position.

The movable object may be controlled remotely by a user. For example, the movable object may be controlled with the aid of a controlling terminal and/or monitoring terminal. The user may be remote from the movable object, or on or in the movable object while using the controlling terminal and/or monitoring terminal to control the movable object. The movable object may be an unmanned movable object, such as a UAV. An unmanned movable object, such as a UAV, may not have an occupant onboard the movable object. The movable object may be controlled by a human or an autonomous control system (e.g., a computer control system), or any suitable combination thereof. The movable object may be an autonomous or semi-autonomous robot, such as a robot configured with artificial intelligence.

The movable object may have any suitable size and/or dimensions. In some embodiments, the movable object may be of a size and/or dimensions to have a human occupant within or on the vehicle. Alternatively, the movable object may be of size and/or dimensions smaller than that capable of having a human occupant within or on the vehicle. The movable object may be of a size and/or dimensions suitable for being lifted or carried by a human. Alternatively, the movable object may be larger than a size and/or dimensions suitable for being lifted or carried by a human.

An exemplary movable object 300 is a UAV. The UAV may include a propulsion system having four rotors. Any number of rotors may be provided (e.g., one, two, three, four, five, six, or more). The rotors, rotor assemblies, or other propulsion systems of the unmanned aerial vehicle may enable the unmanned aerial vehicle to hover/maintain position, change orientation, and/or change location. The distance between shafts of opposite rotors may be any suitable length. Any description herein of a UAV may apply to a movable object, such as a movable object of a different type, and vice versa.

In some embodiments, the movable object may be configured to carry a load. The load may include one or more of passengers, cargo, equipment, instruments, and the like. The load may be provided within a housing. The housing may be separate from a housing of the movable object, or be part of a housing for a movable object. Alternatively, the load may be provided with a housing while the movable object does not have a housing. Alternatively, portions of the load or the entire load may be provided without a housing. The load may be rigidly fixed relative to the movable object. Optionally, the load may be movable relative to the movable object (e.g., translatable or rotatable relative to the movable object).

In some embodiments, the load may include a payload. In some embodiments, the payload may be configured to implement methods for simulating visual data as disclosed herein. For example, a movable object may be an UAV and the payload may include a recording unit 16 described above with reference to FIG. 3. The recording unit may be configured to capture images, videos, sound, and other data of the surroundings of the UAV. The captured data such as videos may be streamed back down to a control terminal or base station. UAVs are typically exposed to elements of nature and/or attacks of hostile forces, causing malfunction and/or to damage to the UAV and payload carried by the UAV, for example, due to weather conditions, impact from landing/takeoff or surrounding obstacles, and the like. For example, a turbulence, impact or even crash of the UAV may cause a disconnect or damage to a component critical to recording operation of the recording unit, thereby disrupting the recording. As such, a recording unit carried by such a UAV should be prepared to recover gracefully from potentially frequent disruption of recordings caused by such abnormal events so as to protect the recorded media content data.

The payload may be configured not to perform any operation or function. Alternatively, the payload may be a payload configured to perform an operation or function, also known as a functional payload. For example, the payload may be an image capturing device. Any suitable sensor may be incorporated into the payload, such as an image capture device (e.g., a camera), an audio capture device (e.g., a parabolic microphone), an infrared imaging device, or an ultraviolet imaging device. The sensor may provide static sensing data (e.g., a photograph) or dynamic sensing data (e.g., a video). In some embodiments, the sensor provides sensing data for the target of the payload.

Alternatively or in combination, the payload may include one or more emitters for providing signals to one or more targets. Any suitable emitter may be used, such as an illumination source or a sound source. In some embodiments, the payload includes one or more transceivers, such as for communication with a module remote from the movable object. For example, the communication may be with a terminal device described herein. Optionally, the payload may be configured to interact with the environment or a target. For example, the payload may include a tool, instrument, or mechanism capable of manipulating objects, such as a robotic arm.

Optionally, the load may include a carrier. The carrier may be provided for the payload and the payload may be coupled to the movable object via the carrier, either directly (e.g., directly contacting the movable object) or indirectly (e.g., not contacting the movable object). Conversely, the payload may be mounted on the movable object without requiring a carrier. The payload may be integrally formed with the carrier. Alternatively, the payload may be releasably coupled to the carrier. In some embodiments, the payload may include one or more payload elements, and one or more of the payload elements may be movable relative to the movable object and/or the carrier, as described above.

The carrier may be integrally formed with the movable object. Alternatively, the carrier may be releasably coupled to the movable object. The carrier may be coupled to the movable object directly or indirectly. The carrier may provide support to the payload (e.g., carry at least part of the weight of the payload). The carrier may include a suitable mounting structure (e.g., a gimbal platform or a gimbal stabilizer) capable of stabilizing and/or directing the movement of the payload. In some embodiments, the carrier may be adapted to control the state of the payload (e.g., position and/or orientation) relative to the movable object. For example, the carrier may be configured to move relative to the movable object (e.g., with respect to one, two, or three degrees of translation and/or one, two, or three degrees of rotation) such that the payload maintains its position and/or orientation relative to a suitable reference frame regardless of the movement of the movable object. The reference frame may be a fixed reference frame (e.g., the surrounding environment). Alternatively, the reference frame may be a moving reference frame (e.g., the movable object, a payload target).

In some embodiments, the carrier may be configured to permit movement of the payload relative to the carrier and/or movable object. The movement may be a translation with respect to up to three degrees of freedom (e.g., along one, two, or three axes) or a rotation with respect to up to three degrees of freedom (e.g., about one, two, or three axes), or any suitable combination thereof.

In some instances, the carrier may include a carrier frame assembly and a carrier actuation assembly. The carrier frame assembly may provide structural support to the payload. The carrier frame assembly may include individual carrier frame components, some of which may be movable relative to one another. The carrier actuation assembly may include one or more actuators (e.g., motors) that actuate movement of the individual carrier frame components. The actuators may permit the movement of multiple carrier frame components simultaneously, or may be configured to permit the movement of a single carrier frame component at a time. The movement of the carrier frame components may produce a corresponding movement of the payload. For example, the carrier actuation assembly may actuate a rotation of one or more carrier frame components about one or more axes of rotation (e.g., roll axis, pitch axis, or yaw axis). The rotation of the one or more carrier frame components may cause a payload to rotate about one or more axes of rotation relative to the movable object. Alternatively or in combination, the carrier actuation assembly may actuate a translation of one or more carrier frame components along one or more axes of translation, and thereby produce a translation of the payload along one or more corresponding axes relative to the movable object.

FIG. 2 is a block diagram illustrating a simulation system 200 for simulating visual data, consistent with exemplary embodiments of the present disclosure. The simulation system 200 may correspond to a physical system or physical objects. For example, the simulation system 200 may be embodied as a specialized computer or server system. For another example, the simulation system 200 may be a computer comprising one or more physical processors programmed by computer program instructions that, when executed, cause the one or more physical processors to perform one or more methods described in this disclosure. For yet another example, the simulation system 200 may be implemented as an application on a computer, simulator, or smart device (e.g., smart phone or tablet). For yet another example, the simulation system 200 may be implemented on or as a part of a single device, e.g., a movable object, a controller of the movable object, a virtual reality helmet, a simulator, a pair of glasses, a contact lens, a wearable device, etc. For yet another example, the simulation system 200 may be implemented by more than one device.

The simulation system 200 may include an I/O unit 201, a communication unit 205, a processing unit 204, a storage unit 203, and a display 202, some of which may be optional. For example, the display 202 and/or the I/O unit 201 can be optional when the simulation system 200 is a server box. The components of the simulation system 200 may be operatively connected to each other via a bus or other types of communication channels. The components of the simulation system 200 may be physical components. In some embodiments, the simulation system 200 may include many more components than those shown in FIG. 2. However, it is not necessary that all of these components be shown in order to disclose an illustrative embodiment.

The I/O unit 201 may include a keyboard, a printer, a display, a touch screen, a microphone, etc. The I/O unit 201 may be configured to input/output signals to/from the simulation system 200. For example, the I/O unit 201 may be configured to provide a user interface to operate the system 200, e.g., a joystick or a touch screen to receive signals for changing a viewing angle of simulated images.

The communication unit 205 may include connectors for wired communications, wireless transmitters and receivers, and/or wireless transceivers for wireless communications. The communications may comprise control signals and/or data. The connectors, transmitters/receivers, or transceivers may be configured for two-way communication between the simulation system 200 and various devices. For example, the communication unit 205 may send and receive operating signals and/or data to and from the movable object 300. For another example, the communication unit 205 may send and receive operating signals and/or data to and from a remote device, e.g., instructions from a remote mobile phone. In some embodiments, the communication unit 205 may be configured to transmit information with the movable object 300. The information may be transmitted to and/or from the movable object via wireless communication. The information transmission is described in more details below with reference to FIG. 4.

The display 202 may be configured to provide visual data to a user. The display 202 may be optional. The provided visual data may be raw visual data, rendered visual data, simulated visual data, transformed visual data, and so on. Such data may include audio, image, and video obtained by executing one or more steps in one or more methods described herein. The visual data may also be controllable via a user interface, e.g., the I/O unit 201, to manipulate, edit, or otherwise use the visual data based on user inputs.

The storage unit 203 may include transitory and/or non-transitory storage media or memories configured to store data, logic, code, and/or program instructions executable by the processing unit 204 for performing one or more routines or functions, and/or steps and methods disclosed herein. The storage unit 203 may include one or more memory units (e.g., flash memory card, random access memory (RAM), read-only memory (ROM), and the like). In some embodiments, inputs from the I/O unit 201 can be conveyed to and stored within the memory units of the storage unit 203. Although FIG. 2 depicts a single processing unit 204 and a single memory 203, one of skill in the art would appreciate that this is not intended to be limiting, and that the simulation system 200 may include a plurality of processing units and/or memory units of the memory.

The storage unit 203 may include instructions for implementing a simulation engine 214, a rasterization engine 224, and an encoder 234. The processing unit 204 may be configured to execute the instructions stored in the storage unit 203 corresponding to the simulation engine 214, the rasterization engine 224, and the encoder 234. In some other embodiments, the simulation engine 214, the rasterization engine 224, and/or the encoder 234, or portions of the simulation engine 214, the rasterization engine 224, and/or the encoder 234 may be implemented in software, hardware (e.g., GPU, FPGA), or a combination of both. The simulation engine 214 may be configured to perform one or more method described herein, e.g., method 500. The rasterization engine 224 and the encoder 234 may be optional. The rasterization engine 224 may be similar to the rasterization engine 411 described above, but incorporated into the simulation system 200. The encoder 234 may be configured to convert data, information, or signal from one format/code to another for the purposes of standardization, speed, or compression. In some embodiments, the compression standard used by the encoder 234 may include H.264, JPEG, or JPEG2000. The use of the compression standards may decrease the response time of generated data.

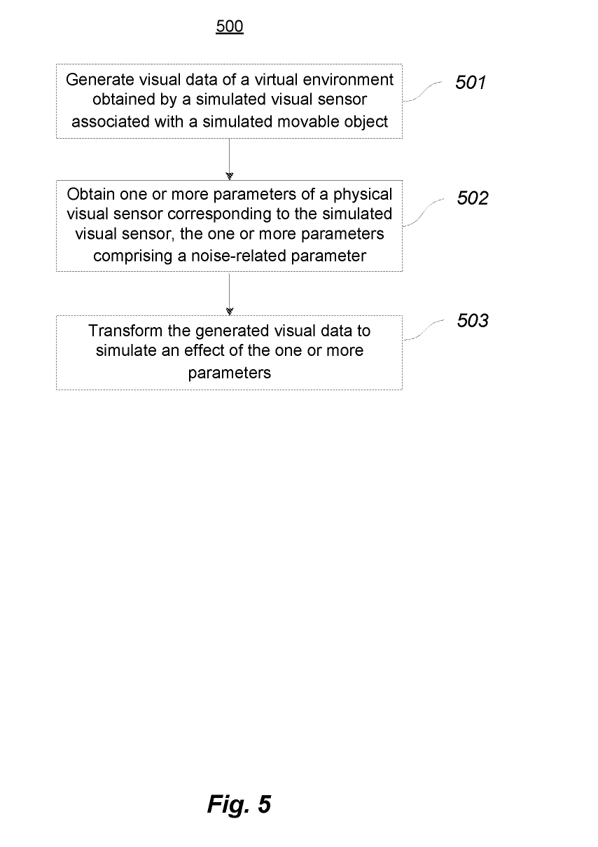

The processing unit 204 may include one or more processors, such as a programmable processor (e.g., a central processing unit (CPU), FPGA, ASIC). In some embodiments, the processing unit 204 may include one or more GPUs and/or ASIC for fast and efficient generation of virtual data. The simulation engine 214 may be implemented as or as a part of the CPU or the GPU. In some embodiments, one or more components of the simulation system 200, such as the simulation engine 214, may be configured to execute one or more instructions stored in the storage unit 203 to implement one or more methods described herein. The implemented methods may include simulating, rendering, or transforming visual data. Detailed descriptions of the methods are provided below with reference to FIG. 4 and FIG. 5.

FIG. 3 is a block diagram illustrating a movable object 300, consistent with exemplary embodiments of the present disclosure. An exemplary movable object is a UAV. The movable object 300 may include a sensor unit 11, a processing unit 12, a storage unit 13, a driving unit 14, a power unit 15, and a communication unit 18, some of which may be optional. The components of the movable object 300 may be operatively connected to each other via a bus or other types of communication channels. Some components of the movable object 300 may be integrated into one unit or one component. For example, the sensor unit 11 may be integrated with the processing unit 12. In the case that the simulation system 200 is embodied on or as a part of the movable object 300, the processing unit 204 may also function as the processing unit 12. These components of the movable object 300 may be physical components. In some embodiments, the movable object 300 may include many more components than those shown in FIG. 3. However, it is not necessary that all of these components be shown in order to disclose an illustrative embodiment.

The sensor unit 11 may include a recording unit 16 and an environment sensing unit 17. The sensor unit 11 may comprise one or more physical sensors implemented as the recording unit 16 and/or the environment sensing unit 17. The recording unit 16 and the environment sensing unit 17 may be integrated as one sensor or operate as discrete sensors. The sensor unit 11 may comprise or combine different types of sensors that collect information relating to the surroundings of the movable object 300. The sensors may detect and/or measure different types of signals. Various data, such as 3D scenes, map data, and state information, may be captured by the sensor unit 11, by another module or device outside the movable object 300 (e.g., the computing device 400 described above), or by a combination of the movable object 300 and the outside module or device. Such data may be received and transformed by the simulation system 200.

The recording unit 16 may include any device capable of recording and/or processing audio, video, still images, or other signals as analog or digital data. Exemplary recording units may include cameras (e.g., digital cameras), camcorders, video cameras, digital media players (PMPs), camera phones, smart phones, personal digital assistants (PDAs), tablet computing devices, laptop computers, desktop computers, smart TVs, game consoles, and the like. The recording unit 16 may include image sensors, detectors, lenses, other optical components, microphones, and the like. In some embodiments, the recording unit 16 may include vision/image sensors configured to collect visual signals (e.g., pictures, videos) and/or microphones configured to collect sound signals. The recording unit 16 can also be configured to cause storage of data representing audio, video, images, text, or other analog or digital signals on various data storage devices, e.g., the storage unit 13, and/or to generate media files for playback or streaming based on the recorded data. In this disclosure, the visual/image sensors can be referred to as detectors and vice versa.

The environment sensing unit 17 may include sensors configured to obtain information of the environment, e.g., temperature, altitude, etc. The processing unit 12 in conjunction with the environment sensing unit 17 may determine state information of the movable object 300 based on the obtained information of the environment. The environment information may include, for example, a temperature, a humidity, or a wind speed of the environment of the movable object 300. The state information may include, for example, a current position in 3D space, a pose, or a motion of the movable object 300. In some embodiments, the environment sensing unit 17 may include inertial sensors, position sensors (e.g., GPS and magnetometer), range sensors (e.g., ultrasound, infrared, and light detection and ranging (LIDAR)), and the like to collect information. In some embodiments, the state information is not limited to being captured by the sensing unit 17, but also can be generated by an outside device, e.g., the computing device 400 and received by the processing unit 12. For example, the processing unit 12 may receive control commands from a controller implemented as the computing device 400, instructing the movable object 300 to hover around an object. The control command data may be an exemplary source for the state information.

The processing unit 12 may control the operation of the movable object 300. For example, the processing unit 12 may control the recording unit 16 to capture the visual data, and/or control the driving unit 14 to maneuver the movable object 300. In some embodiments, the processing unit 12 may perform analog-to-digital conversion of audio, video, or other signals, compression or decompression of the signals using one or more coding algorithms, encryption and/or decryption of recorded data, playback, transmission and/or streaming of recorded data, and the other functionalities. In some embodiments, after capturing visual data, the movable object 300 may store the captured visual data in the storage unit 13, the simulation system 200, the computing device 400, and/or another network device.

The storage unit 13 may store data captured, processed, generated, simulated, rendered, or otherwise used by the movable object 300. In various embodiments, the storage unit 13 may be based on semiconductor, magnetic, optical, or any suitable technologies and may include flash memory, USB drives, memory cards, solid-state drives (SSDs), hard disk drives (HDDs), floppy disks, optical disks, magnetic tapes, and the like. In some embodiments, the storage unit 13 may include instructions that can be executed by the processing unit 12 to implement various functionalities of the UAV, such as sensing, navigation, obstacle avoidance, etc. Based on a more accurate simulation of the captured image, the simulated visual data disclosed herein can be used to provide better testing for such instructions.

The driving unit 14 may control one or more components of movable object 300 to effectuate movements or to change a state of the movable object 300. For example, the driving unit 14 may include rotors of a UAV, which may drive the UAV in any direction in the air.

The power unit 15 may supply power to one or more components of the movable object 300. The power unit 15 may include regular batteries (e.g., lithium-ion batteries), wirelessly chargeable batteries, and solar panel powered batteries (e.g., batteries attached to light-weight solar panels disposed on a UAV).

The communication unit 18 may include connectors for wired communications, wireless transmitters and receivers, and/or wireless transceivers for wireless communications. The communications may comprise control signals and/or data. The connectors, transmitters/receivers, or transceivers may be configured for two-way communication between the movable object 300 and various devices. For example, the communication unit 18 may send and receive information such as operating signals and/or data to and from the simulation system 200 wirelessly. The information transmission is described in more details below with reference to FIG. 4.

FIG. 4 is a flowchart illustrating data exchange among the system 100 for simulating visual data, consistent with exemplary embodiments of the present disclosure. Various sub-components of the simulation system 200, the movable object 300, and the computing device 400, described with reference to earlier figures, are not shown in FIG. 4. Any data path or step described below may be optional or may be combined. An objective of the data flow may include simulating realistic images as captured by a physical UAV-based physical camera.

In some embodiments, the simulation system 200 may extract 3D scenes 401 from stored 3D virtual environment models. For example, the 3D scenes 401 may be determined based on a current state of the virtual UAV and its sensors with respect to the virtual environment. The extracted 3D scenes may be a portion of the entire virtual environment as if captured by the UAV. The current state of the UAV and its sensors may be derived from simulated sensor data captured by the UAV's sensors. The states of the UAV may include, for example, a position, a pose, a speed, a velocity, an acceleration, and/or an orientation. The parameters for deriving the UAV sensor's state may include physical parameters of a lens or detector of the visual sensor, e.g., field of view, lens distortion angle, detector size, etc. These parameters may be a part of parameters 405 described below. Next, the rasterization engine 224 of the simulation system 200 may receive the 3D scenes 401 and accordingly render raw 2D visual data 402. The rendering may process the 3D scenes for display on a 2D screen. The simulation engine 214 of the simulation system 200 may receive the raw 2D visual data 402 and produce transformed visual data 406 based on the parameters 405.

In some other embodiments, the rasterization engine 411 of the computing device 400 may perform the functions of the rasterization engine 224. The computing device 400 may receive 3D visual data 403 from the network 101, the removable memory device 102, and/or direct input. Alternatively, the 3D visual data may be pre-stored, self-simulated, derived from another 3D model accessible to the computing device 400, etc. Based on the 3D visual data 403, the computing device 400 may render raw 2D visual data 404, and transmit it to the simulation engine 214 of the simulation system 200.

The simulation engine 214 may be configured to transform the received raw 2D visual data into transformed visual data 406 based on one or more parameters 405. The simulation engine 214 may also receive one or more parameters 405 from the network 101, removable memory device 102, and/or direct input. That is, the parameters 405 may come from the simulation system 200, the movable device 300, another device such as a cellphone connected to the network 101, a user entry, a default setting, etc. The parameters 405 may include noise-related parameters, such as the parameters of onboard sensor detectors and lenses described in more details below with reference to FIG. 5 to FIG. 11. The simulation engine 214 may transform the raw 2D visual data based on the parameters 405. In the transformation process, the simulation system 200 may simulate one or more components of the movable object 300 (e.g., components described with reference to FIG. 3), and their physical properties, associated operations, functions, performances, effects, etc. For example, the simulation system 200 may simulate an output (e.g., a captured image) by a camera onboard of the movable object 300 by transforming rendered visual data. The transformation and its sub-steps such as optical simulation and detector simulation are described in more details below with reference to FIG. 5. The simulation engine 214 may include instructions for implementing one or both of the optical simulation and the detector simulation. In particular, the simulation may incorporate various noises to the visual data. The transformed visual data 406 is transmitted to encoder 234 to convert format for standardization, speed, and/or compression.

In some embodiments, the simulation system 200 may provide the encoded transformed visual data 407 to users or user devices, e.g., to a display screen, to a computer of a test/algorithm development engineer for better testing of vision-based algorithms, such as navigation, mapping, collision avoidance, path planning, tracking, etc. In some embodiments of a “hardware-in-loop” scenario, the simulation system 200 may generate a virtual movable object and associated virtual sensors (e.g., virtual GPS, virtual gimbal, virtual gyroscope), and provide the encoded transformed visual data 407 to the movable object 300. The encoded transformed visual data 407 may also include non-visual information (e.g., a UAV position, onboard camera orientation). The physical movable object 300 may receive the simulated sensor data, and the logic onboard the UAV (e.g., comprised in flight controller or vision-based algorithms such as UAV path planning and obstacle avoidance) may generate a control command 408 based on the received visual data to actuate the movable object 300. The simulation system 200 may then receive the generated control command 408 from the movable object 300 to update the state of the simulated movable object (e.g., position or orientation in a model of the physical movable object and/or of a corresponding simulated movable object). Thus, the vision-based algorithms can be tested with the stream of the transformed visual data looped between the movable object and the simulation system.

FIG. 5 is a flowchart illustrating a method 500 for simulating visual data, consistent with exemplary embodiments of the present disclosure. The method 500 may comprise a number of steps, some of which may be optional or may be rearranged in another order. One or more steps of the method 500 may be implemented by one or more components of the simulation system 200, such as the processing unit 204, and/or any other suitable system, such as the computing device 400.

At step 501, visual data of a virtual environment is generated. The visual data of the virtual environment may represent data obtained by a simulated visual sensor associated with a simulated movable object. In some embodiments, the visual data may be generated by one or more GPUs, embodied as the processing unit 204.

In some embodiments, the virtual environment may correspond to a real environment, such as an open space, a rain forest, a stadium, etc. The virtual environment may be simulated, provided, received, selected, captured, rendered, stored, retrieved, generated, or otherwise obtained by the simulation system 200. In some embodiments, a device outside the simulation system 200, independently or jointly with the system 200, may obtain data representing the virtual environment, and transmit the virtual environment data to one or more components of the simulation system 200. In some embodiments as mentioned above with reference to FIG. 4, information of the virtual environment is contained in one or more 3D models stored in the storage unit 203 or otherwise accessible to the simulation system 200. The 3D models are described in more details below. The virtual environment may or may not be displayed and/or rendered, as long as the visual data required by the step 501 is generated. There may be various methods to create the virtual environment. For example, the virtual environment may be generated based on images of a certain building interior gathered from internet. For another example, a physical device may capture a physical environment, based on which the virtual environment is generated.

In some embodiments, the visual data (e.g., 3D visual data, 3D scenes) may represent output of a simulated visual sensor associated with a simulated movable object. The visual data may comprise images of the virtual environment as captured by such a simulated visual sensor at various times and/or at various poses. The simulated visual sensor of the simulated movable object may correspond to a physical visual sensor of a physical movable object (e.g., a UAV).

As discussed with reference to FIG. 4, the raw 2D visual data may be derived from the 3D visual data/scenes determined based on a current state of the virtual UAV and its sensor with respect to the virtual environment. In some embodiments, the virtual environment is represented by one or more the 3D models. The 3D models may be stored in the storage unit 203 or be retrieved from another device in the system 100 (e.g., a sensor of the movable object 300, a network computing device, or the rasterization engine 411). The 3D models may be individually selected and retrieved according to user inputs, user preferences, or types (e.g., wide-view or infrared) or state information (e.g., position or orientation) of the movable object or image sensor. Each 3D model may comprise a collection of virtual scenes.

The simulation system 200 may extract 3D scenes from one or more selected 3D models based on a current state of the virtual UAV and its sensor with respect to the virtual environment. The current state may include simulated, stored, or received state information of the movable object and/or the virtual visual sensor relative to a position system of the virtual environment. Information of the position system may be referred to as map data (including 2D and/or 3D map data) of the virtual environment. The state information is described below in more details.

In some embodiments, the state information may comprise one or more of the following types of information associated with the simulated visual sensor: a 3D position, an orientation, a field of view, and zoom information. In some embodiments, the state information may comprise one or more of the following types of information associated with the simulated movable object: flight mode information, altitude information, moving direction information, and velocity information. The flight mode information may include predetermined flight modes stored in the storage unit 13 or the storage unit 203, or may be determined dynamically during operation of the UAV. For example, the flight modes may include a tracking mode (e.g., tracking people, animals, or objects), a watching mode (e.g., watching one or more objects by adjusting gimbal configuration of a camera of an operating UAV in real time, such that the one or more objects remain in a field of view of the camera), a point of interest (POI) mode (e.g., controlling the UAV to hover about a user-defined point of interest and/or to film a 360 degree video of the point of interest), etc.

In some embodiments, the simulation system 200 may convert the 3D scenes in vector formats to raster formats. The converted visual data may be referred to as the raw 2D visual data or the generated visual data. The simulation system 200 may receive one or more 3D scenes, and compute mapping from a geometry associated with the one or more 3D scenes to pixels of a 2D surface. Alternatively, the computing device 400 may perform the above steps. In some embodiments, the rasterization step may be skipped, for example, if the original scene is already rasterized (e.g., if the 3D models provide 2D scenes).

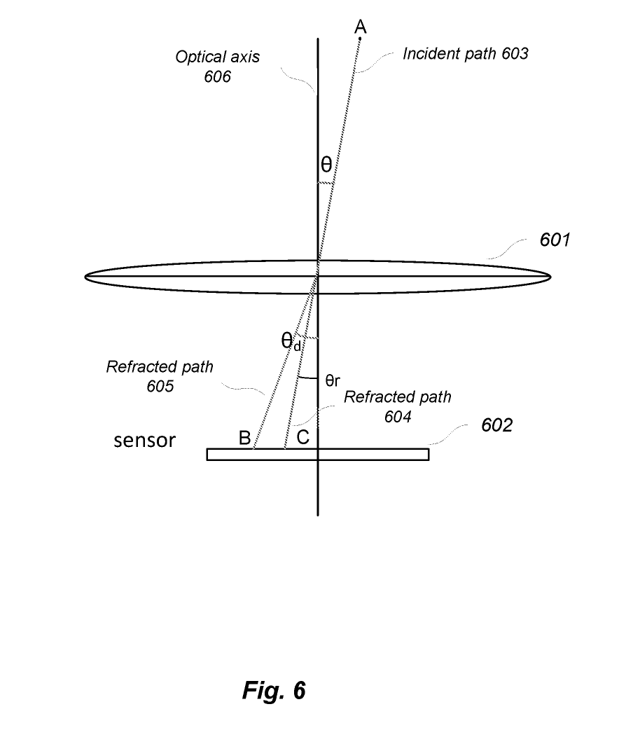

At step 502, one or more parameters of a physical visual sensor corresponding to the simulated visual sensor are obtained, the one or more parameters comprising a noise-related parameter. The one or more parameters are described in more details below with reference to FIG. 6 to FIG. 11.

In some embodiments, the simulated visual sensor may include a simulated lens and a simulated detector configured to capture virtual images through the simulated lens, the simulated lens corresponding to a physical lens of the physical visual sensor, and the simulated detector corresponding to a physical detector of the physical visual sensor. The one or more parameters may be related to the optics (e.g., lenses) and/or the image sensors (e.g., detectors) of the imaging device/visual sensor (e.g., camera). For example, the parameters related to the optics may include focal length, refractive index, and distortion model of the lenses (e.g., a model that relates the incident ray direction and the output ray direction); and the parameters related to the image sensors may include sensor size, photon noise, and heat noise. The one or more parameters may be configurable and may be configured by a user, a configuration file, a real-time setting, etc. The one or more parameters may be obtained through a network, a memory transfer, a user-input, etc.

The noise-related parameters may include various types. For example, one or more parameters of a physical camera onboard a physical UAV may be obtained as the noise-related parameters of a corresponding virtual onboard camera of a virtual UAV flying in a virtual environment. The physical visual sensor may include one or more lenses and one or more detectors, e.g., CCD or CMOS detectors, configured to capture visual data through the one or more lenses. Correspondingly, the simulated visual sensor may include one or more simulated lenses and one or more simulated detectors. Properties of the physical lenses and/or detectors, such as optical properties, material properties, and chemical properties, may be simulated in the virtual visual sensor to mimic the physical camera.

At step 503, the visual data generated at step 501 is transformed to simulate an effect of the one or more parameters. For example, the simulation system 200 may re-calculate, adjust, or modify the generated visual data to simulate an effect of the one or more parameters. The effect may include, for example, a noise effect, an optical effect, etc. By simulating the effect of the one or more parameters, the transformed visual data can allow better testing of vision-based algorithms, e.g., navigation, mapping, collision avoidance, path planning, tracking, etc.

In some embodiments, the simulated visual sensor may include a simulated lens and a simulated detector configured to capture virtual images through the simulated lens, the simulated lens corresponding to a physical lens of the physical visual sensor, and the simulated detector corresponding to a physical detector of the physical visual sensor. In the real world and correspondingly in the simulation, photons from an environment may pass through a lens and impinge on a detector. The lens' properties may affect the path of the photons and/or the quantity of passing photons. Based on a photoelectric effect, the detector may convert the impinging photons on each detector pixel to a number of electrons, which is ultimately converted to a pixel value reading corresponding to the pixel.

The one or more parameters of method 500 described above may include optical parameters. Three examples of the optical parameters are described below with respect to individual models. In some embodiments, the one or more parameters of the physical visual sensor may include a field of view of the physical lens, and the field of view may be determined by a focal length f of the physical lens and a size d of the physical detector. For example, the

$$= 2 arc tan \frac{d}{2 f} .$$

angle of view a may be related to d and f by the formula: Through this field of view model, the transformed visual data can have a similar field of view to the physical visual sensor.

In some embodiments, the one or more parameters of the physical visual sensor may include a distortion model of the physical lens as shown in FIG. 6. FIG. 6 is a ray diagram illustrating a lens distortion model consistent with exemplary embodiments of the present disclosure. Incident path 603 is a path of light impinging on a lens 601. Refracted path 604 is a theoretical ray of light from the optical center of the lens 601 to reach a detector 602. The theoretical path may be based on an assumption of a perfect and shapeless lens 601. Refracted path 605 is an actual ray of light deviating from the theoretical path 604 after passing through the lens 601. The deviation may be caused by, for example, a physical shape, a material perturbation, a defect, an imperfect installation of single or multi lens pieces, or a surface property of the lens 601. The point C where the refracted path 604 intersects with the detector 602 indicates a theoretical position of the captured visual data corresponding to point A and the incident light. The point B where the refracted path 605 intersects with the detector 602 indicates a real position of the captured visual data corresponding to point A and the same incident light. θ is an incident angle between the incident path 603 and an optical axis 606. Or is a refraction angle between the refracted path 604 and the optical axis 606. θ_{d} is a refraction angle between the refracted path 605 and the optical axis 606. θ_{d} or a difference between θ_{d} and θᵣ can be referred to as the distortion angle. θ and θ_{d} may be related by: θ_{d}=Σᵢ₌₀ⁿkᵢθ²ⁱ⁺¹, where n is a natural number indicating an accuracy of the distortion angle, k₀=1, and other k values are associated with the lens properties. The k values can be simulated or experimentally determined. As illustrated in FIG. 6, the real position B as generated by the lens distortion model shifts from the theoretical position C by the traditional method. In reality, point A's image captured in the detector 602 is closer to point B than point C due to the inherent distortion property of lenses. The same effect applies to other points, pixels, and complete images captured via the lens 601. Therefore, by this lens distortion model, the transformed visual data can reflect a similar distortion as that present in the physical visual sensor, which is not included in simulation results produced by the conventional methods. That is, this lens distortion model may correct certain inaccurate simulation results rendered by the conventional methods.

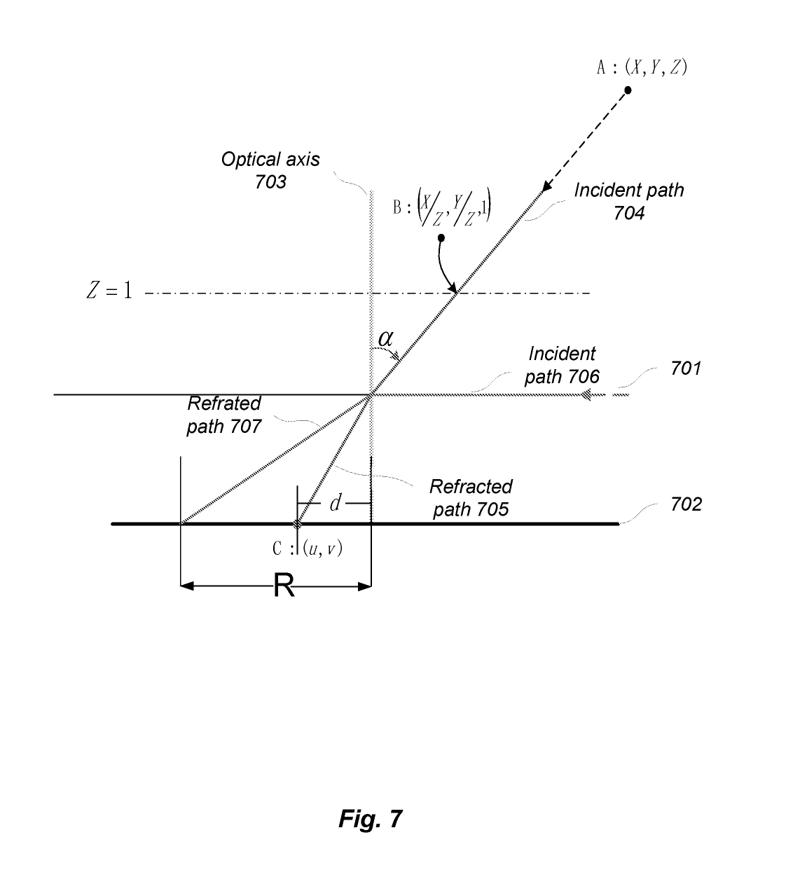

In some embodiments, the one or more parameters of the physical visual sensor may include a refractive index of the physical lens as shown in FIG. 7. FIG. 7 is a ray diagram illustrating a fisheye model consistent with exemplary embodiments of the present disclosure. The plane 701 is a lens plane, the plane 702 is a sensor or detector plane, the vertical line is an optical axis 703, incident path 704 is a ray path from object A with coordinates (X, Y, Z) to the lens plane 701, refracted path 705 is a ray path corresponding to A after passing the lens plane 701, α is an incident angle between the incident path 704 and the optical axis 703, B (X/Z, Y/Z, 1) is an intersection point between the incident path 704 and a plane Z=1, C (u, v) is a detected signal position corresponding to A and in the sensor plane 702, d is a distance from C to the optical axis 703, incident path 706 is an extreme example of the ray path where light passes horizontally from right and refracts via refracted path 707 to an extreme left end of the sensor plane 702 corresponding to a field of view (FOV) of 180 degrees, R is a radius of the sensor measured centered at the optical axis 703, and

$$\frac{d}{R} = \frac{α}{FOV / 2} .$$

According to this fisheye model, all visual data within the 180 degree FOV, e.g., anything above the lens plane 701, can be captured by the sensor, and corresponding d values can be determined. To this end, the R and FOV may be simulated to achieve the fisheye model. Alternatively, the lens refractive index or the refractive index between the lens plane 701 and the sensor plane 702 may be simulated in the transformed visual data to achieve the fisheye effect. Therefore, through this fisheye model, the transformed visual data can have a wider FOV, which is not included in simulation results rendered by the conventional methods. That is, parts of images beyond the FOV of traditionally simulated images may be simulated with the fisheye model. Further, based on the description above, a wide variety of cameras including fisheye cameras can be simulated by corresponding models. This allows experimentation and/or verification of a larger set of algorithms than currently available that rely on images from such cameras. For instance, even without installing fisheye cameras on physical UAVs, UAV algorithms based on the fisheye camera model can be tested.

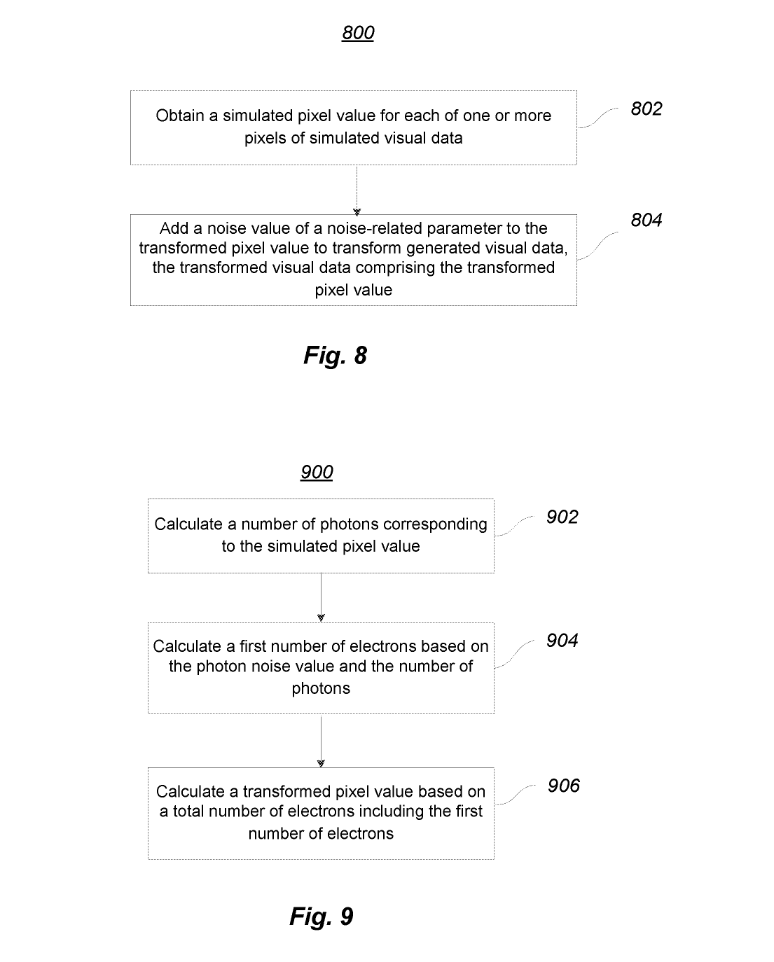

FIG. 8 is a flowchart illustrating a method 800 for simulating visual data, consistent with exemplary embodiments of the present disclosure. In some embodiments, method 800 may be used to implement step 503 of method 500 described above. That is, the method 800 may be performed to transform the generated visual data to simulate the effect of the one or more parameters. The method 800 may be performed by one or more components of the simulation system 200, e.g., the simulation engine 214. The noise-related parameter may comprise a noise value. The noise value can be positive, negative, or zero.

At step 802, a simulated pixel value is obtained for each of one or more pixels of the simulated visual data. For example, the pixel value may be represented by a 8-bit color scale corresponding to 256 colors. One of ordinary skill in the art would appreciate that other representations such as a 24-bit color scale may also be used.

At step 804, the noise value is added to the simulated pixel value to obtain a transformed pixel value, the transformed visual data comprising the transformed pixel value. For example, the noise value is −10, and by adding −10 to the simulated pixel value of 125, a transformed pixel value of 115 can be obtained. Similarly, by additionally transforming other simulated pixel values of the simulated visual data, the transformed visual data can be obtained. The noise value may be added uniformly to the simulated pixel value, according to a distribution (e.g., Gaussian distribution), or based on another configurable rule.

FIG. 9 is a flowchart illustrating a method 900 for simulating photon noise, consistent with exemplary embodiments of the present disclosure. In some embodiments, method 900 may be used to implement step 804 of method 800 described above. That is, the method 900 may be performed to transform the generated visual data to simulate the effect of the one or more parameters. The noise value may comprise a photon noise value. The method 900 may be performed by one or more components of the simulation system 200, e.g., the simulation engine 214.

At step 902, a number of photons is calculated corresponding to the simulated pixel value. In this step, a photon-pixel value conversion and/or a dynamic range may be modeled. For the photon-pixel value conversion, for example, a number of effective photons Nₕᵥ exciting electrons on a pixel may be equal to a product of a corresponding pixel reading value V and a projection parameter, e.g., a (gain) parameter a of the imaging system: Nₕᵥ=αV. That is, a physical detector may proportionally convert a number of effective photons impinging on each pixel of the detector to a corresponding pixel value. Conversely, a simulated pixel value can be used to work backwards to obtain a simulated number of photons. For the dynamic range, it may be defined as the largest achievable signal divided by the noise of the imaging system. Since rendered images may have undergone an HDR (high dynamic range) process from rasterization, they may have a dynamic range larger than that of images captured by the corresponding physical sensor. Thus, pixel reading values V of the rendered images may be corrected nonlinearly by Gamma correction to V^{γ}, with γ being a Gamma correction parameter. Combining both the photon-pixel conversion and the dynamic range modeling, the number of photons Nₕᵥ corresponding to the simulated pixel value may be calculated as: Nₕᵥ=αV^{γ}, where V is the simulated pixel value normalized to [0, 1], γ is a configurable parameter, and α is a projection parameter. If it is know that the rasterization has already employed a Gamma correction, γ will be an inverse of the Gamma correction parameter used in the rasterization. Here, α and γ may be configurable parameters. The configuration may be performed by, for example, a user, an administrator, or an algorithm. The configuration may be performed via various terminals, such as a touch interface implemented as the display 202, or a mobile device coupled to the simulation system 200. The configuration may be performed dynamically or at predetermined times. The configurability described above is generally applicable to any parameters described herein. In some embodiments, the Gamma correction may be omitted and step 902 may be implemented by linear projection, that is calculating the number of photons proportionally from the simulated pixel value.

At step 904, a first number of electrons is calculated based on the photon noise value and the number of photons. For example, a base number of electrons N′ₑ may be obtained by N′ₑ=Nₕᵥ·η_{QE}, where η_{QE} is a quantum efficiency, and the first number of electrons may be obtained by correcting the base number of electrons based on a photon noise models. The base number of electrons N′ₑ may be corrected by adding a photon noise value δ_{q}, that is, N′ₑ+δ_{q}.

In some embodiments, the photon noise value δ_{q} may follow a Poisson distribution function, which can approximate to a Gaussian distribution function when the number of electrons is large: δ_{q}˜N(0, \sqrt{N′ₑ}). In some embodiments, the number of photons corresponding to the simulated pixel value may be higher than the real number of photons, since in a real environment not all of the impinging photons on the detectors can cause the photoelectric effect. The photon noise may effectively model the loss of photons that do not ultimately contribute to the detector signals or pixel readings. Thus, by simulating the photon noise, the first number of electrons can more realistically represent the number of electrons excited by the effective number of photons that ultimately contribute to the detector signals or pixel readings.

At step 906, the transformed pixel value is calculated based on a total number of electrons including the first number of electrons.

In some embodiments, converting the total number of electrons to the transformed pixel value (analog to digital transformation) may involve a readout noise. The readout noise δᵣ may follow a normal distribution with a standard deviation of σᵣ. That is, δᵣ˜N(0, σᵣ). The standard deviation may be obtained from a manual or similar sources of the physical visual sensor/detector. In some embodiments, the standard deviation may be up to 100 electrons. The transformed pixel value V_{raw} may be V_{raw}=Nₑ/g, where Nₑ=N′ₑ+δ_{q}+δᵣ and g is a gain of the detector (e.g., a number of electrons represented by an analog-to-digital conversion unit).

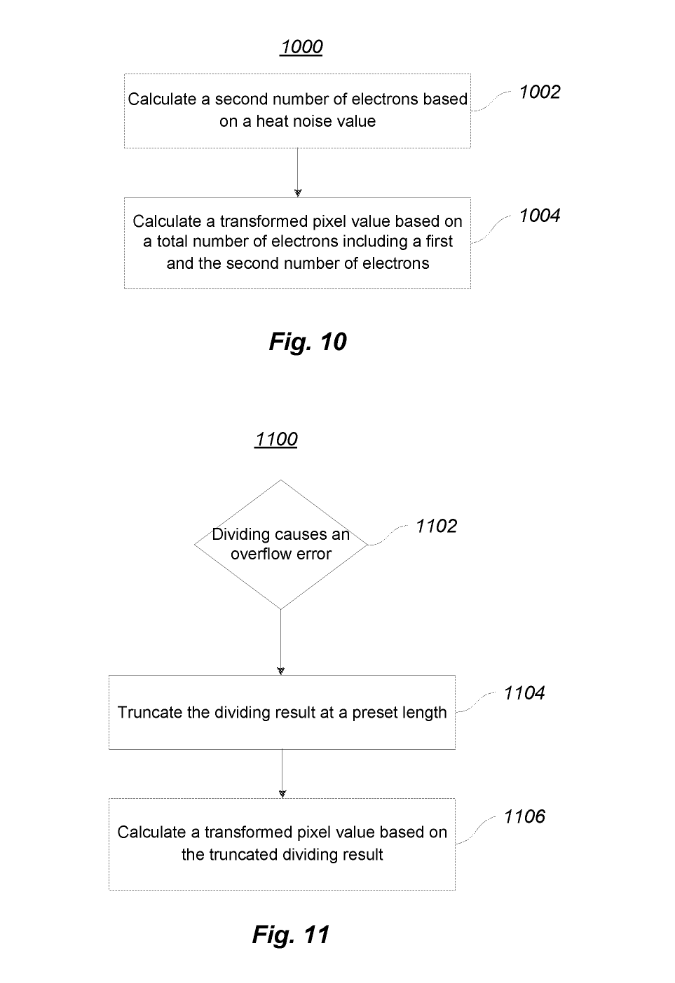

FIG. 10 is a flowchart illustrating a method 1000 for simulating heat noise, consistent with exemplary embodiments of the present disclosure. In some embodiments, the method 1000 may be used to implement step 906 of the method 900 described above. That is, the method 1000 may be performed to transform the generated visual data to simulate the effect of the one or more parameters. The noise value may comprise a heat noise value. The method 1000 may be performed by one or more components of the simulation system 200, e.g., the simulation engine 214.

At step 1002, a second number of electrons is calculated based on the heat noise value. The heat noise may also be referred to as dark shot noise, dark current shot noise, or dark current heat noise. For example, the base number of electrons N′ₑ may be corrected by heat noise value, regardless of whether having been corrected by the photon noise value. If a photon noise model has been applied, the second number of electrons may be obtained by correcting the first number of electrons by adding a heat noise value δ_{d}, that is N′ₑ+δ_{q}+δ_{d}+δᵣ. The heat noise value δ_{d} may follow a Poisson distribution function, which can approximate to a Gaussian distribution function when the number of electrons is large: δ_{d}˜N(nₑt,\sqrt{nₑt}), wherein nₑ is a number of dark current electrons per pixel per unit time, and t is an exposure time. In some embodiments, the heat noise value δ_{d} may also model a temperature of the detector or environment and its effect on detector signals/pixel readings. Since semiconductor carrier speeds are significantly affected by the temperature, the heat noise value δ_{d} may affect the photon detection signals. Accordingly, the heat noise value δ_{d} can be generated based on a configurable temperature, e.g., a real or simulated temperature of the detector, the visual sensor, or the environment.

At step 1004, the transformed pixel value is calculated based on the total number of electrons including the first and second number of electrons. In some embodiments, converting the total number of electrons to the transformed pixel value (analog to digital transformation) may also involve the readout noise σᵣ. Therefore, the transformed pixel value V_{raw2} may be V_{raw2}=Nₑ/g, where Nₑ=N′ₑ+δ_{q}+δ_{d}+δᵣ. Thus, by simulating the heat noise, the second number of electrons Nₑ can model a change of the number of exited electrons associated with a dark current. Incorporating the first and second number of electrons can more realistically reflect the number of electrons excited by the real number of photons and that ultimately contribute to the detector signals or pixel readings.

FIG. 11 is a flowchart illustrating a method 1100 for simulating visual data, consistent with exemplary embodiments of the present disclosure. In some embodiments, method 1100 may be used to implement step 1004 or step 906 described above. That is, the method 1100 may be performed to transform the generated visual data to simulate the effect of the one or more parameters. The method 1100 may be performed by one or more components of the simulation system 200, e.g., the simulation engine 214.

At step 1102, it is determined if the calculation of V_{raw} described in step 1004 or step 906 causes an overflow error. If yes, the method 1100 may proceed to step 1104. An overflow error may occur when calculation of V_{raw} or V_{raw2} exceeds a pixel reading limit. For example, for an 8-bit color system, the maximum pixel value reading is 255.

At step 1104, the dividing result is truncated at a preset length. For example, a pixel value reading larger than 255 for the 8-bit system may be truncated to 255. In some embodiments, the gain of the physical image sensor can be adjusted to effectuate adjustments to brightness of the visual data. This gain, like other parameters, is also configurable.

At step 1106, the transformed pixel value is calculated based on the truncated dividing result. For example, truncated pixel values may be used as the transformed pixel value to obtain the transformed visual data.

In some embodiments, the methods described above with reference to FIGS. 8-11 may be applicable to single color visual sensors, and before step 802, the simulation system 200 may optionally transform the generated visual data to greyscale visual data.

In some embodiments, for color Bayer visual sensors, the methods described with reference to FIGS. 8-11 may be modified at the step 902 to calculate the number of photons. For example, for every pixel in the Bayer array of the visual sensor, a corresponding RGB type may be determined, and the simulated pixel value is converted to the number of photons according to the determined RGB type, since different color may have different conversion parameters.

As described above, various properties of physical lenses and detectors, including optical and material properties, may be modeled to simulate visual data. Compared to traditionally simulated visual data where only global filters are applied, the transformed visual data may simulate effects based on physical properties of corresponding hardware and is thus more realistic. Further, the simulation may be accomplished by one or more GPUs, without data transmission between video RAMs and system memories, thus achieving a high quality and a quick response time.

Another aspect of the disclosure is directed to a non-transitory computer-readable storage medium storing instructions which, when executed, cause one or more processors to perform the methods, as discussed above. The computer-readable storage medium may include volatile or non-volatile, magnetic, semiconductor, tape, optical, removable, non-removable, or other types of computer-readable storage medium or computer-readable storage devices. For example, the computer-readable storage medium may be the storage unit or the memory module having the computer instructions stored thereon, as disclosed. In some embodiments, the computer-readable storage medium may be a disc or a flash drive having the computer instructions stored thereon.

A person skilled in the art can further understand that, various exemplary logic blocks, modules, circuits, and algorithm steps described with reference to the disclosure herein may be implemented as specialized electronic hardware, computer software, or a combination of electronic hardware and computer software. For examples, the modules/units may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present disclosure. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a computer, an embedded processor, or other programmable data processing devices to produce a special purpose machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer-readable memory that can direct a computer or other programmable data processing devices to function in a particular manner, such that the instructions stored in the computer-readable memory produce a manufactured product including an instruction means that implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions (which are executed on the computer or other programmable devices) provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage can be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

The specification has described methods, apparatus, and systems for simulating visual data. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with the disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present disclosure is not limited to the exact construction that has been described above and illustrated in the accompanying drawings, and that various modifications and changes can be made without departing from the scope thereof. It is intended that the scope of the invention should only be limited by the appended claims.

What is claimed is:

1. A visual simulation system, comprising:
a non-transitory computer-readable memory that stores computer-executable instructions; and
one or more processors, individually or collectively, configured to access the memory and execute the computer-executable instructions to:
generate visual data of a virtual environment obtained by a simulated visual sensor associated with a simulated movable object;
obtain one or more parameters of a physical visual sensor corresponding to the simulated visual sensor, the one or more parameters comprising a noise-related parameter; and
transform the generated visual data to simulate an effect of the one or more parameters.

2. The system of claim 1, wherein:
the simulated visual sensor includes a simulated lens corresponding to a physical lens of the physical visual sensor;
the one or more parameters comprise at least one of a focal length of the physical lens, a distortion angle of the physical lens, or a refractive index of the physical lens; and
the one or more processors are, individually or collectively, configured to access the memory and execute the computer-executable instructions to transform the generated visual data to simulate the at least one of the focal length of the physical lens, the distortion angle of the physical lens, or the refractive index of the physical lens.

3. The system of claim 1, wherein:
the simulated visual sensor includes a simulated detector corresponding to a physical detector of the physical visual sensor;
the one or more parameters comprise a size of the physical detector; and
the one or more processors are, individually or collectively, configured to access the memory and execute the computer-executable instructions to transform the generated visual data to simulate the size of the physical detector.

4. The system of claim 1, wherein the one or more processors are, individually or collectively, further configured to access the memory and execute the computer-executable instructions to simulate movement of the simulated movable object based on the transformed visual data.

5. The system of claim 4, wherein the one or more processors are, individually or collectively, configured to access the memory and execute the computer-executable instructions to:
receive at least one of map data of the virtual environment or state information of the simulated movable object; and
simulate movement of the simulated movable object based on the at least one of the received map data or the received state information.

6. The system of claim 1, wherein the one or more processors are, individually or collectively, configured to access the memory and execute the computer-executable instructions to transmit the transformed visual data to a processor of a physical movable object.

7. The system of claim 1, wherein:
the noise-related parameter comprises a noise value; and
to transform the generated visual data to simulate the effect of the one or more parameters, the one or more processors are, individually or collectively, configured to access the memory and execute the computer-executable instructions to:
obtain a simulated pixel value for each pixel of the simulated visual data; and
add the noise value to the simulated pixel value to obtain a transformed pixel value, wherein the transformed visual data comprises the transformed pixel value.

8. The system of claim 7, wherein:
the noise value comprises at least one of a photon noise value or a heat noise value; and
to add the noise value to the simulated pixel value to obtain the transformed pixel value, the one or more processors are, individually or collectively, configured to access the memory and execute the computer-executable instructions to:
calculate at least one of:
a first number of electrons based on the photon noise value and a number of photons corresponding to the simulated pixel value; or
a second number of electrons based on the heat noise value; and
calculate the transformed pixel value based on a total number of electrons including at least one of the first number of electrons or the second number of electrons.

9. The system of claim 8, wherein:
the simulated visual sensor includes a simulated detector; and
to calculate the number of photons corresponding to the simulated pixel value, the one or more processors are, individually or collectively, further configured to access the memory and execute the computer-executable instructions to:
convert the simulated pixel value to another pixel value according to a dynamic range of a physical detector corresponding to the simulated detector; and
convert the another pixel value to the number of photons.

10. The system of claim 8, wherein, to calculate the transformed pixel value based on the total number of electrons, the one or more processors are, individually or collectively, further configured to access the memory and execute the computer-executable instructions to:
calculate an intermediate pixel value based on the total number of electrons; and
calculate the transformed pixel value by dividing the intermediate pixel value by a gain of a physical detector corresponding to a simulated detector of the simulated visual sensor.

11. A visual simulation method, comprising:
generating visual data of a virtual environment obtained by a simulated visual sensor associated with a simulated movable object;
obtaining one or more parameters of a physical visual sensor corresponding to the simulated visual sensor, the one or more parameters comprising a noise-related parameter; and
transforming the generated visual data to simulate an effect of the one or more parameters.

12. The method of claim 11, wherein:
the simulated visual sensor includes a simulated lens corresponding to a physical lens of the physical visual sensor;
the one or more parameters comprise at least one of a focal length of the physical lens, a distortion angle of the physical lens, or a refractive index of the physical lens; and
transforming the generated visual data to simulate the effect of the one or more parameters comprises transforming the generated visual data to simulate the at least one of the focal length of the physical lens, the distortion angle of the physical lens, or the refractive index of the physical lens.

13. The method of claim 11, wherein:
the simulated visual sensor includes a simulated detector corresponding to a physical detector of the physical visual sensor;
the one or more parameters comprise a size of the physical detector; and
transforming the generated visual data to simulate the effect of the one or more parameters comprises transforming the generated visual data to simulate the size of the physical detector.

14. The method of claim 11, further comprising simulating movement of the simulated movable object based on the transformed visual data.

15. The method of claim 14, wherein simulating the movement of the simulated movable object based on the transformed visual data comprises:
receiving at least one of map data of the virtual environment or state information of the simulated movable object; and
simulating the movement of the simulated movable object based on the at least one of the received map data or the received state information.

16. The method of claim 11, wherein:
the noise-related parameter comprises a noise value; and
transforming the generated visual data to simulate the effect of the one or more parameters comprises:
obtaining a simulated pixel value for each pixel of the simulated visual data; and
adding the noise value to the simulated pixel value to obtain a transformed pixel value, wherein the transformed visual data comprises the transformed pixel value.

17. The method of claim 16, wherein:
the noise value comprises at least one of a photon noise value or a heat noise value; and
adding the noise value to the simulated pixel value to obtain the transformed pixel value comprises:
calculating at least one of:
a first number of electrons based on the photon noise value and a number of photons corresponding to the simulated pixel value; or
a second number of electrons based on the heat noise value; and
calculating the transformed pixel value based on a total number of electrons including at least one of the first number of electrons or the second number of electrons.

18. The method of claim 17, wherein:
the simulated visual sensor includes a simulated detector; and
the number of photons corresponding to the simulated pixel value is calculated by:
converting the simulated pixel value to another pixel value according to a dynamic range of a physical detector corresponding to the simulated detector; and
converting the another pixel value to the number of photons.

19. The method of claim 17, wherein calculating the transformed pixel value based on the total number of electrons comprises:
calculating an intermediate pixel value based on the total number of electrons; and
calculating the transformed pixel value by dividing the intermediate pixel value by a gain of a physical detector corresponding to a simulated detector of the simulated visual sensor.

20. One or more non-transitory computer-readable storage media having stored thereon executable instructions that, when executed by one or more processors of a system, cause the system to:
generate visual data of a virtual environment obtained by a simulated visual sensor associated with a simulated movable object;
obtain one or more parameters of a physical visual sensor corresponding to the simulated visual sensor, the one or more parameters comprising a noise-related parameter; and
transform the generated visual data to simulate an effect of the one or more parameters.
